(19) United States
(12) Patent Application Publication
(10) Pub. No.: US 2025/0011084 A1
(43) Pub. Date: Jan. 9, 2025

(54) LOAD HANDLING SYSTEMS AND METHODS OF USE

(71) Applicant: INTELLIGRATED HEADQUARTERS, LLC, Mason, OH (US)

(72) Inventor: Vishwanath Malagi, Bengaluru (IN)

(21) Appl. No.: 18/348,013

(22) Filed: Jul. 6, 2023

(51) Int. Cl. B65G 1/04

(52) U.S. Cl. CPC B65G 1/0492; B65G 2207/00

(57) ABSTRACT

Methods, systems, assemblies, and/or the like are provided. In some embodiments, an adjustable load handling system (ALHS) includes one or more load arms, wherein the one or more load arms are configured to operably engage one or more totes; a cam assembly including: a cam wheel; and a guide plate including one or more guide slots, wherein the one or more load arms are disposed within the one or more guide slots, and wherein the one or more load arms are operably engaged with the cam wheel such that a rotation of the cam wheel causes the one or more load arms to slide along the one or more guide slots relative to the cam wheel; and a motor operably engaged with the cam assembly, wherein the motor is configured to drive the rotation of the cam wheel.

### TECHNICAL FIELD

The present disclosure relates generally to load handling systems for shuttle carts. In particular, it relates to adjusting a load handling system in a shuttle cart for automated retrieval and storage of one or more totes.

### BACKGROUND

Load handling systems may be used in warehouses, distribution centers, and other industrial environments to place and/or take one or more totes, tray, cartons, etc. distribution throughout the environment. Various totes may have differing sizes and dimensions; further, they some may be placed in locations that are harder to access than others. The mechanism by which the load handling system may be complicated, inefficient, and/or in capable of handling such totes.

Through applied effort, ingenuity, and innovation, Applicant has solved problems relating to load handling systems by developing solutions embodied in the present disclosure, which are described in detail below.

### SUMMARY

In general, embodiments of the present disclosure provide load handling systems, automated storage and retrieval systems, methods, and/or the like.

In accordance with various embodiments of the present disclosure there is provided an adjustable load handling system (ALHS) including one or more load arms, wherein the one or more load arms are configured to operably engage one or more totes; a cam assembly including: a cam wheel; and a guide plate including one or more guide slots,

wherein the one or more load arms are disposed within the one or more guide slots, and wherein the one or more load arms are operably engaged with the cam wheel such that a rotation of the cam wheel causes the one or more load arms to slide along the one or more guide slots relative to the cam wheel; and a motor operably engaged with the cam assembly, wherein the motor is configured to drive the rotation of the cam wheel.

In some embodiments, the ALHS further includes an actuator; and a carriage, wherein the cam assembly is disposed on the carriage, and wherein the actuator is configured to translate the carriage relative to the one or more totes.

In some embodiments, the ALHS further includes a mount plate; and a block, wherein the cam assembly is disposed on the block, wherein the block is disposed on the mount plate, wherein the motor is disposed on the mount plate, and wherein the mount plate is disposed on the carriage.

In some embodiments, the one or more load arms include one or more guide pins, the cam wheel defines one or more wheel tracks, and the one or more guide pins are disposed within the one or more wheel tracks, such that the rotation of the cam wheel causes the one or more pins to slide along the one or more wheel tracks relative to the guide plate.

In some embodiments, the motor is a servo motor or a stepper motor.

In some embodiments, the rotation of the cam wheel in a first direction causes the one or more load arms to move closer to the guide plate, and the rotation of the cam wheel in a second direction causes the one or more load arms to move farther from the guide plate.

In some embodiments, wherein the cam wheel includes a wheel alignment hole, the guide plate includes a plate alignment hole, and at least a portion of the motor is disposed through the wheel alignment hole and the plate alignment hole.

In some embodiments, the rotation of the cam wheel in a first direction causes the one or more load arms to operably engage with the one or more totes, and the rotation of the cam wheel in a second direction causes the one or more load arms to refrain from operably engaging with the one or more totes.

In some embodiments, the first direction is clockwise and the second direction is counterclockwise.

In some embodiments, the one or more load arms includes a first load arm and a second load arm, and

In some embodiments, the first load arm is disposed on a first side of the cam assembly and the second load arm is disposed on a second side of the cam assembly.

In some embodiments, the first load arm and the second load arm are symmetrical with respect to the guide plate.

In some embodiments, the first load arm and the second load arm are separated by a distance, wherein the rotation of the cam wheel in a first direction causes the distance to decrease, and wherein the rotation of the cam wheel in a second direction causes the distance to increase.

In accordance with various embodiments, there is provided an automated storage and retrieval system (ASRS) including a shuttle cart assembly having a cart frame including one or more wheel mounts and one or more frame slots; one or more load arms, wherein the one or more load arms are configured to operably engage one or more totes; a cam assembly including: a cam wheel; and a guide plate having one or more guide slots, wherein the one or more load arms are disposed within the one or more guide slots, wherein the one or more load arms are operably engaged with the cam wheel such that a rotation of the cam wheel causes the one or more load arms to slide along the one or more guide slots relative to the guide plate, and wherein the cam assembly is disposed within the cart frame; and a motor operably engaged with the cam assembly, wherein the motor is configured to drive the rotation of the cam wheel.

In some embodiments, the ASRS further includes an actuator disposed within the one or more actuator slots; and a carriage, wherein the cam assembly is disposed on the carriage, and wherein the actuator is configured to translate the carriage relative to the cart frame.

In some embodiments, the ASRS further includes a mount plate; and a block, wherein the cam assembly is disposed on the block, wherein the block is disposed on the mount plate, wherein the motor is disposed on the mount plate, wherein the mount plate is disposed on the carriage, and wherein the carriage is disposed on the actuator.

In some embodiments, the one or more load arms include one or more guide pins, the cam wheel defines one or more wheel tracks, and the one or more guide pins are disposed within the one or more wheel tracks, such that the rotation of the cam wheel causes the one or more pins to slide along the one or more wheel tracks relative to the guide plate.

In some embodiments, the one or more load arms include a first load arm and a second load arm, and the first load arm is disposed on a first side of the cam assembly and the second load arm is disposed on a second side of the cam assembly.

In some embodiments, the first load arm and the second load arm are symmetrical with respect to the guide plate.

In some embodiments, the first load arm and the second load arm are separated by a distance, the rotation of the cam wheel in a first direction causes the distance to decrease, and the rotation of the cam wheel in a second direction causes the distance to increase.

According to various embodiments, there is provided a method of adjusting a load handling system, the method including: inserting one or more load arms into a guide slot of a guide plate of a cam assembly; aligning one or guide pins of one or more load arms with one or more tracks of a cam wheel of a cam assembly; rotating, by a motor, the cam wheel, such that the one or more guide pins travel along the one or more tracks relative to the cam wheel and the one or more load arms slide along the one or more guide slots relative to the guide plate; and translating, by a actuator, the cam assembly relative to a cart frame of a shuttle cart.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is an isometric view of an example automated storage and retrieval system (ASRS) in accordance with various embodiments of the present disclosure;

FIG. 2 is a top plan view of an example automated storage and retrieval system (ASRS) in accordance with various embodiments of the present disclosure;

FIG. 3 is an isometric view of an example ALHS in accordance with various embodiments of the present disclosure;

FIG. 4 is an exploded view of an example ALHS in accordance with various embodiments of the present disclosure;

FIG. 5 is an isometric view of an example ALHS in accordance with various embodiments of the present disclosure;

FIG. 6 is a top plan view of an example ALHS in accordance with various embodiments of the present disclosure; and

FIG. 7 is an example flow chart illustrating an example method of use of an example ALHS in accordance with various embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

### Overview

According to various embodiments, an adjustable load handling system (ALHS) may include one or more load arms configured to operably engage one or more totes; that is, the one or more load arms may take, move, and place one or more totes.

In some embodiments, the ALHS may include a cam assembly, which may be configured to adjust the positions of the one or more load arms. In some embodiments, the cam assembly may include a cam wheel having one or more wheel tracks, which may be configured to receive one or pins disposed on the load arms. In some embodiments, the cam assembly may include a guide plate having one or more guide slots, in which the load arms may be disposed. In some embodiments, as the pins of the load arms slide within the wheel tracks, the load arms may subsequently slide along the one or more guide slots, causing them to either spread farther from the cam assembly (moving relative to the wheel) or come closer to the cam assembly. That is, in some embodiments, rotation of the cam wheel may cause (depending on the direction of rotation) the load arms to extend (e.g., to position themselves around a tote), or to compress (e.g., to close around a tote and thereby secure it for movement). In some embodiments, the cam assembly may be coupled to a motor, which may drive this rotation of the cam wheel.

In some embodiments, the ALHS may be coupled to an actuator, which may be configured to drive the cam assembly. In some embodiments, the actuator may be a linear actuator configured to laterally drive the cam assembly in one or more directions. In some embodiments, the actuator may be configured to drive the cam assembly (and, by extension, the one or more load arms) into proximity with the one or more totes, such that the one or more arms can be adjusted to close around the one or more totes and thereby take and place the one or more totes.

In some embodiments, the load handling system may be coupled to a mobile device. For example, a load handling system may be integrated into an automated storage and retrieval system (ASRS). In some embodiments, the automated storage and retrieval system may include a shuttle cart having a frame configured to receive the cam assembly and the one or more load arms. In some embodiments, the cart may be configured to run along a track that extends throughout the warehouse or other industrial environment. In some embodiments, platforms may be disposed on either side of the track; the platforms may support one or more totes, and when the cart slides by the platforms on the track, it may stop and retrieve the one or more totes using the load handling system.

### Example ASRS and ALHS Systems

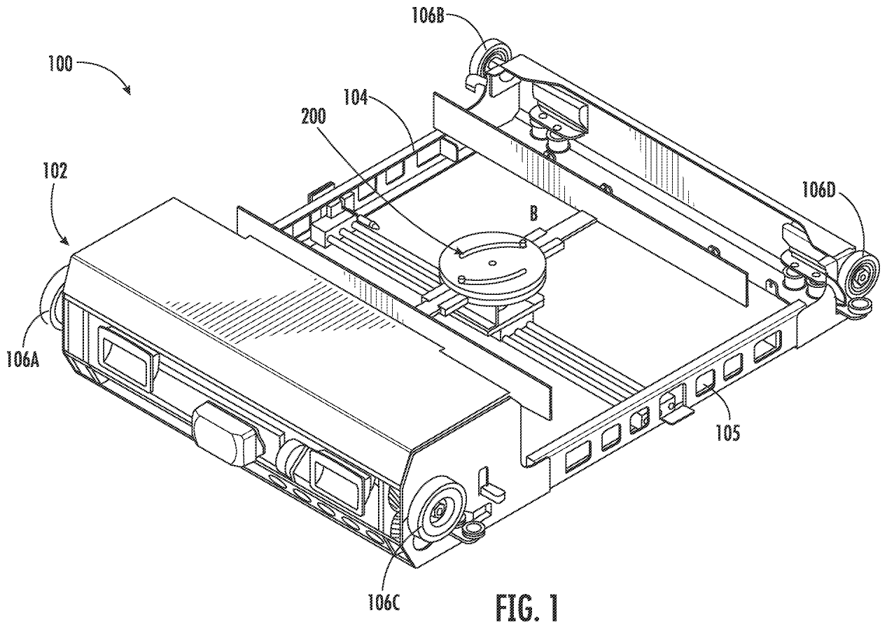

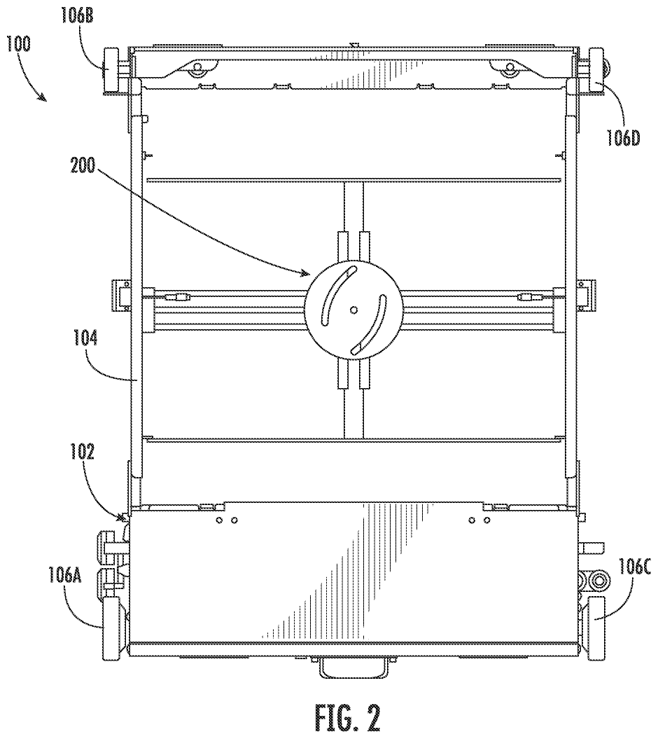

FIG. 1 shows an isometric view of an ASRS 100, and FIG. 2 shows a top plan view of the example ASRS 100, according to various embodiments. In some embodiments, the ASRS 100 includes a shuttle cart assembly 102. In some embodiments, the shuttle cart assembly 102 includes a cart frame 104. In some embodiments, the cart frame 104 may be a substantially rectangular, metal structure into which one or more components of the shuttle cart assembly 102 may be stored. In some embodiments, the cart frame 104 may include one or more frame slots 105, which may be configured to receive one or more components of either the shuttle cart assembly 102, and/or an auxiliary system or assembly.

In some embodiments, the shuttle cart assembly 102 may include one or more wheels 106A-D. In some embodiments, the one or more wheels 106A-D may be configured to run along a track. In some embodiments, the shuttle cart assembly 102 may drive along a track that has been laid throughout a warehouse, distribution center, or similar industrial environment. In some embodiments, the shuttle cart assembly 102 may be an automated cart configured to run along a set route on the track. In some embodiments, the shuttle cart assembly 102 may be remotely controlled on the track by an operator.

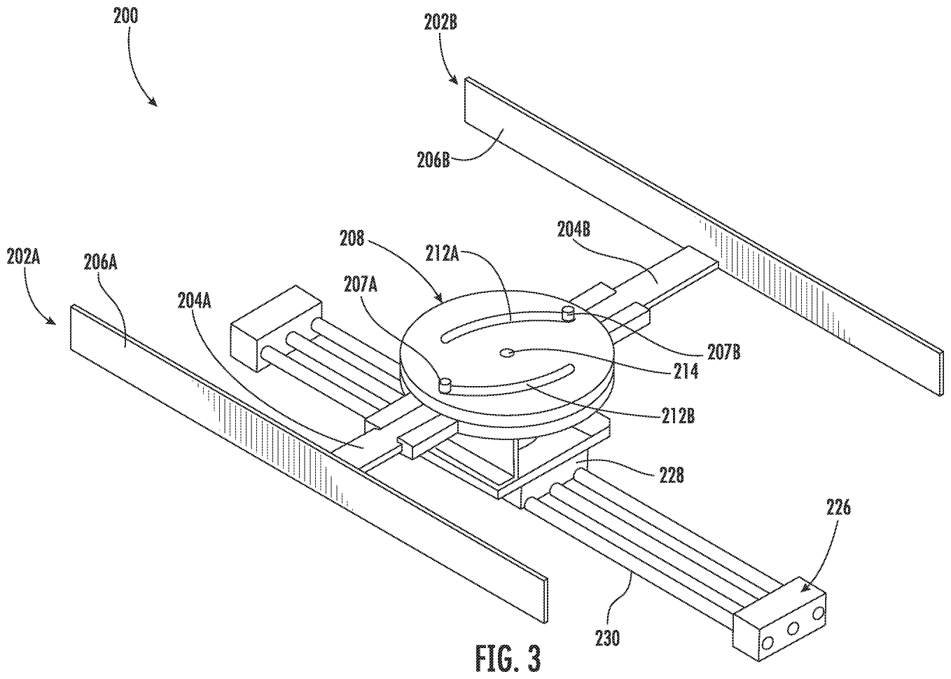

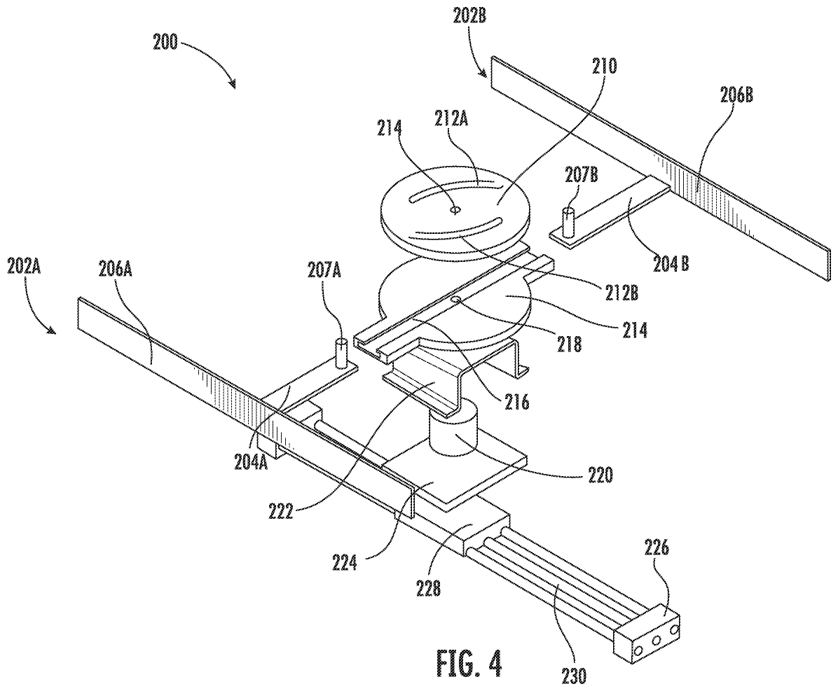

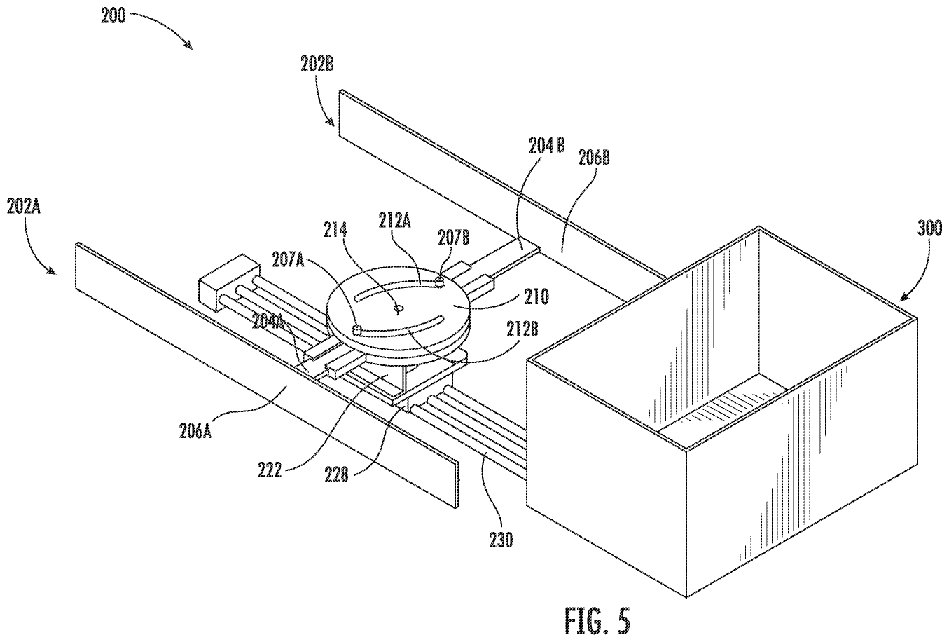

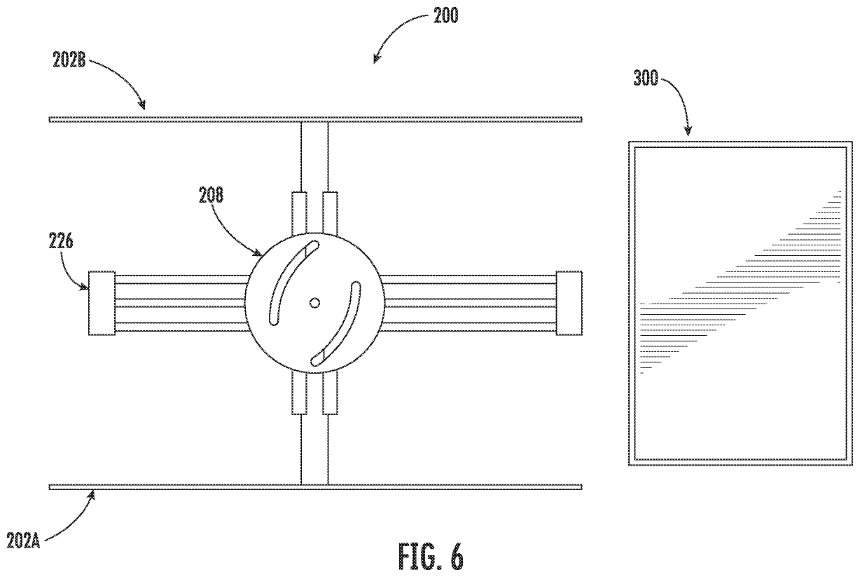

FIG. 3 shows an isometric view of an example ALHS 200, and FIG. 4 shows an exploded view of the example ALHS 200, according to various embodiments. In some embodiments, an ALHS 200 may be engaged (operably or fixedly) with the ASRS 100, or integrated into the ASRS 100, as desired. In some embodiments, the ALHS 200 may include one or more load arms 202A, 202B. In some embodiments, the load arms 202A, 202B may each include an insertion portion 204A, 204B and an attachment portion 206A, 206B. In some embodiments, one or more guide pins 207A-B. In some embodiments, the insertion portion 204A-B and the attachment portions 206A-B may be fixedly attached or a single integrated piece and disposed perpendicular to one another. In some embodiments, the load arms 202A-B may be configured to operably engage with one or more totes 300 (shown in at least FIGS. 5 and 6). In some embodiments, the load arms 202A-B may be substantially rigid; in some embodiments, the load arms 202A-B may be flexible or ductile and configured to deform as necessary.

In some embodiments, the ALHS may include a cam assembly 208. In some embodiments, the cam assembly 208 may be configured to translate rotational motion of one or more of its components into linear motion of the load arms 202A-B.

In some embodiments, the cam assembly 208 may include a cam wheel 210. In some embodiments, the cam wheel 210 may include one or more wheel tracks 212A, 212B. In some embodiments, the one or more wheel tracks 212A-B may be curved and run parallel to the circumference of the cam wheel 210. In some embodiments, the one or more wheel tracks 212A-B may be grooved or slotted. In some embodiments, the one or more guide pins 207A-B may be inserted into the one or more wheel tracks 212A-B and configured to slide along the wheel tracks 212A-B as the cam wheel 210 is rotated. In some embodiments, the cam wheel 210 may include a wheel alignment hole 215 disposed at the center of the cam wheel 210.

In some embodiments, the cam assembly 208 may include a guide plate 214. In some embodiments, the guide plate 214 may include one or more guide slots 216. In some embodiments, the insertion portions 204A-B of the load arms 202A-B may be disposed, at least partially, within the one or more guide slots 216. In some embodiments, the insertion portions 204A-B may be configured to slide within the one or more guide slots 216. In some embodiments, the one or more guide slots 216 may be grooved or slotted, as desired. In some embodiments, the guide plate 214 may be a substantially rigid, rectangular piece. In some embodiments, a plate alignment hole 218 may be disposed at the center of the guide plate 214. In some embodiments, the plate alignment hole 218 may be aligned with the wheel alignment hole 215.

In some embodiments, the ALHS 200 may include a motor 220. In some embodiments, the motor 220 may be a servo motor or a stepper motor, or any other suitable motor configured to rotate the cam assembly 208. In some embodiments, the motor 220 may be configured to drive one or more components of the ALHS 200. In some embodiments, the motor 220 may be configured to drive one or more components of the cam assembly 208, and the cam assembly 208 may be configured to translate the drive of the motor 220 into linear motion for the one or more load arms 202A-B. In some embodiments, the motor 220 may be configured to drive the cam wheel 210 of the cam assembly 208. In some embodiments, the motor 220 may be at least partially disposed through one or more of the wheel alignment hole 215 and the plate alignment hole 218.

In some embodiments, the ALHS 200 may include a block 222. In some embodiments, the block 222 may be disposed between one or more components of the cam assembly 208 and the motor 220. In some embodiments, the block 222 may be a U-shaped block. It will be understood that a variety of different shapes may be used, as desired, for the block 222. In some embodiments, the block 222 may include an alignment hole (not pictured) as with the wheel alignment hole 215 and the plate alignment hole 218, and similarly aligned, and the motor 220 may be at least partially disposed through the wheel, plate, and block alignment holes.

In some embodiments, the ALHS 200 may include a mount plate 224. In some embodiments, the mount plate 224 may be used to mount the motor 220. In some embodiments, the block 222 may also be mounted on the mount plate 224. In some embodiments, the mount plate 224 may be a substantially rigid, rectangular block composed of metal or similar “hard” substance.

In some embodiments, the ALHS 200 may include an actuator 226. In some embodiments, the actuator 226 may be configured to drive one or more components of the ALHS 200. For example, the actuator 226 may be configured to drive one or more components of the cam assembly 208 and thereby move the connected load arms 202A, 202B.

In some embodiments, the actuator 226 may be an electrically-powered linear actuator 226. In some embodiments, the actuator 226 may include a carriage 228 and an actuator track 230. In some embodiments, the actuator 226 may be configured to move the carriage 228 along the actuator track 230. In some embodiments, the actuator track 230 may be substantially linear and disposed within one or more of the frame slots 105 of the frame 104. In some embodiments, one or more components of the cam assembly 208 may be disposed on the carriage 228. In some embodiments, the motor 220, mounted on the mount plate 224, along with the block 222 may be disposed on the carriage 228.

As shown in FIGS. 5 and 6, according to various embodiments, the ALHS 200 may be configured to operable engage one or more totes 300. It will be understood that the ALHS 200 is being shown on its own in order to draw attention to various key features of the system 200. It will further be understood that the disclosure applies similarly whether the ALHS 200 is or is not installed in the ASRS 100.

In some embodiments, the one or more load arms 202A, 202B may be separated by a distance “D.” In some embodiments, the one or more load arms 202A, 202B may be symmetrical about the cam assembly 208, such that the distance D is evenly divided between the “right hand” and “left hand” sides of the ALHS 200. In some embodiments, the motor 220 may drive the cam wheel 210 such that the guide pins 207A-B slide along the one or more wheel tracks 212A-B and the insertion portions 204A-B may subsequently slide within the guide slot 216 of the guide plate 214. Hence, in some embodiments, the rotation of the cam wheel 210 by the motor 220 may cause the one or more load arms 202A, 202B to move such that the distance D is either increased or decreased, depending on the direction of the rotation of the cam wheel 210. In some embodiments, the distance D may increase when the cam wheel 210 rotates counterclockwise and decrease when the cam wheel 210 rotates clockwise; in some embodiments, clockwise may cause an increase while counterclockwise causes a decrease. It will be understood that the expansion and contraction of the distance D between the one or more load arms 202A-B also may be measured with respect to the cam assembly 208 and/or relative to one or more components of the ALHS 200, or the ASRS 100 (assuming the ALHS 200 is installed within the ASRS 100).

In some embodiments, the actuator 226 may drive one or more components of the ALHS 200 (e.g., the load arms 202A-B) into proximity of the one or more totes 300. As one example of operation, according to various embodiments, the actuator 226 may bring the load arms 202A-B into proximity of the one or more totes 300. In some embodiments, the cam assembly 208 may then be driven by the motor 220 to either increase the distance D between the load arms 202A-B (e.g., if the one or more totes 300 is wider than distance D); then, the cam assembly 208 may be driven by the motor 220 to contract the distance D between the one or more load arms 202A-B, such that the distance D approaches the width of the tote. In some embodiments, the one or more load arms 202A-B are then secured around the one or more totes 300, and the one or more totes 300 may be moved/and or placed as desired. A reverse of this procedure may occur to release the one or more totes 300 once they have been moved.

### Example Methods of Use

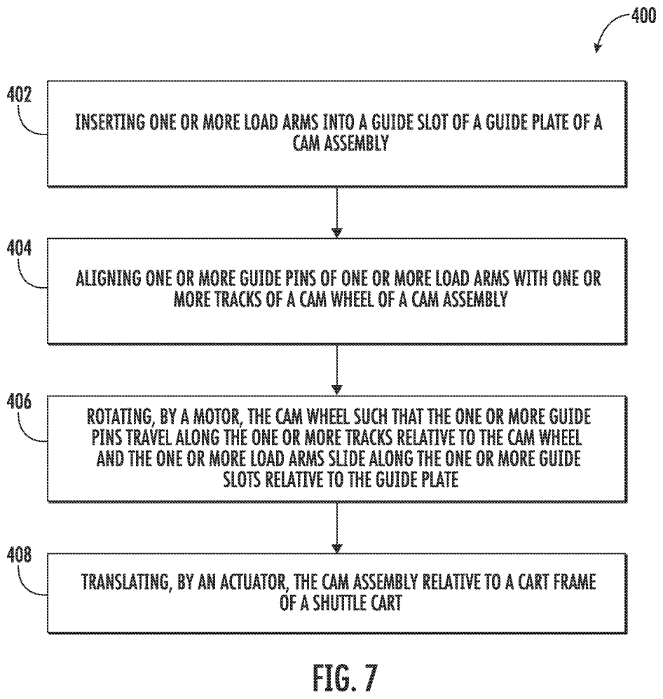

FIG. 7 shows a flow chart illustrating a method 400 of adjusting a load handling system, according to various embodiments. In some embodiments, the method may be used with a load handling system and its various components, as previously described. It will further be understood that the method 400 may be used with any suitable system and components.

In some embodiments, the method 400 may include a step 402 of inserting one or more load arms into a guide slot of a guide plate of a cam assembly. In some embodiments, the method 400 may include a step 404 of aligning one or more guide pins of one or more load arms with one or more tracks of a cam wheel of a cam assembly. In some embodiments, the method 400 may include a step 406 of rotating, by a motor, the cam wheel such that the one or more guide pins travel along the one or more tracks relative to the cam wheel and the one or more load arms slide along the one or more guide slots relative to the guide plate. In some embodiments, the method 400 may include a step 408 of translating, by an actuator, the cam assembly relative to a cart frame of a shuttle cart.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An adjustable load handling system (ALHS) comprising:
one or more load arms,
wherein the one or more load arms are configured to operably engage one or more totes;
a cam assembly comprising:
a cam wheel; and
a guide plate comprising one or more guide slots,
wherein the one or more load arms are disposed within the one or more guide slots, and
wherein the one or more load arms are operably engaged with the cam wheel such that a rotation of the cam wheel causes the one or more load arms to slide along the one or more guide slots relative to the cam wheel; and
a motor operably engaged with the cam assembly,
wherein the motor is configured to drive the rotation of the cam wheel.

2. The ALHS of claim 1, further comprising:
an actuator; and
a carriage,
wherein the cam assembly is disposed on the carriage, and
wherein the actuator is configured to translate the carriage relative to the one or more totes.

3. The ALHS of claim 2, further comprising:
a mount plate; and
a block,
wherein the cam assembly is disposed on the block,
wherein the block is disposed on the mount plate,
wherein the motor is disposed on the mount plate, and
wherein the mount plate is disposed on the carriage.

4. The ALHS of claim 1,
wherein the one or more load arms comprise one or more guide pins,
wherein the cam wheel defines one or more wheel tracks, and
wherein the one or more guide pins are disposed within the one or more wheel tracks, such that the rotation of the cam wheel causes the one or more pins to slide along the one or more wheel tracks relative to the guide plate.

5. The ALHS of claim 1, wherein the motor comprises a servo motor or a stepper motor.

6. The ALHS of claim 1,
wherein the rotation of the cam wheel in a first direction causes the one or more load arms to move closer to the guide plate, and
wherein the rotation of the cam wheel in a second direction causes the one or more load arms to move farther from the guide plate.

7. The ALHS of claim 1,
wherein the cam wheel comprises a wheel alignment hole,
wherein the guide plate comprises a plate alignment hole, and
wherein at least a portion of the motor is disposed through the wheel alignment hole and the plate alignment hole.

8. The ALHS of claim 1,
wherein the rotation of the cam wheel in a first direction causes the one or more load arms to operably engage with the one or more totes, and
wherein the rotation of the cam wheel in a second direction causes the one or more load arms to refrain from operably engaging with the one or more totes.

9. The ALHS of claim 8, wherein the first direction is clockwise and the second direction is counterclockwise.

10. The ALHS of claim 1,
wherein the one or more load arms comprise a first load arm and a second load arm, and
wherein the first load arm is disposed on a first side of the cam assembly and the second load arm is disposed on a second side of the cam assembly.

11. The ALHS of claim 10, wherein the first load arm and the second load arm are symmetrical with respect to the guide plate.

12. The ALHS of claim 11,
wherein the first load arm and the second load arm are separated by a distance,
wherein the rotation of the cam wheel in a first direction causes the distance to decrease, and
wherein the rotation of the cam wheel in a second direction causes the distance to increase.

13. An automated storage and retrieval system (ASRS) comprising:
a shuttle cart assembly comprising:
a cart frame comprising one or more frame slots;
one or more load arms,
wherein the one or more load arms are configured to operably engage one or more totes;
a cam assembly comprising:
a cam wheel; and
a guide plate comprising one or more guide slots,
wherein the one or more load arms are disposed within the one or more guide slots,
wherein the one or more load arms are operably engaged with the cam wheel such that a rotation of the cam wheel causes the one or more load arms to slide along the one or more guide slots relative to the guide plate, and
wherein the cam assembly is disposed within the cart frame; and
a motor operably engaged with the cam assembly,
wherein the motor is configured to drive the rotation of the cam wheel.

14. The ASRS of claim 13, further comprising:
an actuator disposed within the one or more frame slots; and
a carriage,
wherein the cam assembly is disposed on the carriage, and
wherein the actuator is configured to translate the carriage relative to the cart frame.

15. The ASRS of claim 14, further comprising:
a mount plate; and
a block,
wherein the cam assembly is disposed on the block,
wherein the block is disposed on the mount plate,
wherein the motor is disposed on the mount plate,
wherein the mount plate is disposed on the carriage, and
wherein the carriage is disposed on the actuator.

16. The ASRS of claim 13,
wherein the one or more load arms comprise one or more guide pins,
wherein the cam wheel defines one or more wheel tracks, and
wherein the one or more guide pins are disposed within the one or more wheel tracks, such that the rotation of the cam wheel causes the one or more pins to slide along the one or more wheel tracks relative to the guide plate.

17. The ASRS of claim 13,
wherein the one or more load arms comprise a first load arm and a second load arm, and
wherein the first load arm is disposed on a first side of the cam assembly and the second load arm is disposed on a second side of the cam assembly.

18. The ASRS of claim 17, wherein the first load arm and the second load arm are symmetrical with respect to the guide plate.

19. The ASRS of claim 18,
wherein the first load arm and the second load arm are separated by a distance,
wherein the rotation of the cam wheel in a first direction causes the distance to decrease, and
wherein the rotation of the cam wheel in a second direction causes the distance to increase.

20. A method of adjusting a load handling system, the method comprising:
inserting one or more load arms into a guide slot of a guide plate of a cam assembly;
aligning one or guide pins of one or more load arms with one or more tracks of a cam wheel of a cam assembly;
rotating, by a motor, the cam wheel, such that the one or more guide pins travel along the one or more tracks relative to the cam wheel and the one or more load arms slide along the one or more guide slots relative to the guide plate; and
translating, by a actuator, the cam assembly relative to a cart frame of a shuttle cart.
